(19) United States
(12) Patent Application Publication
(10) Pub. No.: US 2015/0005449 A1
(43) Pub. Date: Jan. 1, 2015

(54) BLOCKED MERCAPTOSILANE COUPLING AGENT

(71) Applicants: COMPAGNIE GENERALE DES ETABLISSEMENTS MICHELIN, Clermont-Ferrand (FR); MICHELIN RECHERCE ET TECHNIQUE S.A., Granges-Paccot (CH)

(72) Inventors: Karine Longchambon, Clermont-Ferrand (FR); José Carlos Araujo Da Silva, Clermont-Ferrand (FR); Nicolas Seeboth, Clermont-Ferrand (FR)

(21) Appl. No.: 14/365,484

(22) PCT Filed: Dec. 12, 2012
(86) PCT No.: PCT/EP2012/075239

§ 371 Date: Jun. 13, 2014

(30) Foreign Application Priority Data
Dec. 16, 2011 (FR) 1161781

(51) Int. Cl. C07F 7/08; C08L 9/06

(52) U.S. Cl. CPC C07F 7/0836; C08L 9/06
USPC 525/105; 556/429

(57) ABSTRACT

A blocked mercaptosilane of following general formula (I):

(HO) R₂¹ Si—Z—S—C (═O)—A

in which:
the symbols R¹, which are identical or different, each represent a monovalent hydrocarbon group chosen from linear or branched alkyls, cycloalkyls or aryls having from 1 to 18 carbon atoms;
the symbol A represents hydrogen or a monovalent hydrocarbon group chosen from linear or branched alkyls, cycloalkyls or aryls having from 1 to 18 carbon atoms and linear or branched alkoxyalkyls having from 2 to 8 carbon atoms;
the symbol Z represents a divalent bonding group comprising from 1 to 18 carbon atoms.

This application is a 371 national phase entry of PCT/EP2012/075239, filed 12 Dec. 2012, which claims benefit of FR 1161781, filed 16 Dec. 2011, the entire contents of which are incorporated herein by reference for all purposes.

### BACKGROUND

1. Field

The present disclosure relates to mercaptosilane coupling agents which can be used in particular for the coupling of reinforcing inorganic fillers and diene elastomers in rubber compositions intended, for example, for the manufacture of tires.

2. Description of Related Art

It is known that, generally, in order to obtain the optimum reinforcing properties conferred by a filler, it is advisable for the latter to be present in the elastomeric matrix in a final form which is both as finely divided as possible and as homogeneously distributed as possible. In point of fact, such conditions can only be achieved insofar as the filler exhibits a very good ability, on the one hand, to be incorporated in the matrix during the mixing with the elastomer and to deagglomerate and, on the other hand, to disperse homogeneously in this matrix.

In an entirely known way, carbon black exhibits such abilities, which is not generally the case with inorganic fillers. This is because, for reciprocal affinity reasons, the inorganic filler particles have an unfortunate tendency to clump together in the elastomeric matrix. These interactions have the harmful consequence of limiting the dispersion of the filler and thus the reinforcing properties to a level substantially lower than that which it would be theoretically possible to achieve if all the (inorganic filler/elastomer) bonds capable of being created during the compounding operation were actually obtained. These interactions moreover tend to increase the consistency in the raw state of the rubber compositions and thus to make them more difficult to process than in the presence of carbon black.

Since fuel savings and the need to protect the environment have become a priority, it has, however, proved necessary to produce tires having a reduced rolling resistance, without adversely affecting their wear resistance. This has been made possible in particular by virtue of the discovery of novel rubber compositions reinforced with specific inorganic fillers described as “reinforcing” which are capable of rivalling, from the reinforcing viewpoint, a conventional tire-grade carbon black, while offering these compositions a lower hysteresis, which is synonymous with a lower rolling resistance for the tires comprising them.

Such rubber compositions, comprising reinforcing inorganic fillers of siliceous or aluminous type, have, for example, been described in Patents or Patent Applications EP-A-0 501 227 (or U.S. Pat. No. 5,227,425), EP-A-0 735 088 (or U.S. Pat. No. 5,852,099), EP-A-0 810 258 (or U.S. Pat. No. 5,900,449), EP-A-0 881 252, WO99/02590, WO99/02601, WO99/02602, WO99/28376, WO00/05300 or WO00/05301.

Mention will in particular be made of the documents EP-A-0 501 227, EP-A-0 735 088 or EP-A-0 881 252, which disclose diene rubber compositions reinforced with highly dispersible precipitated silicas, such compositions making it possible to manufacture treads having a markedly improved rolling resistance, without affecting the other properties, in particular those of grip, endurance and wear resistance. Such compositions, exhibiting such a compromise in conflicting properties, are also described in Applications EP-A-0 810 258 and WO99/28376 with, as reinforcing inorganic fillers, specific highly-dispersible aluminous fillers (aluminas or aluminium (oxide) hydroxides), or also in Applications WO00/73372 and WO00/73373, which describe specific titanium oxides of the reinforcing type.

The use of these specific highly dispersible inorganic fillers, as predominant or non-predominant reinforcing filler, has admittedly reduced the difficulties in processing the rubber compositions comprising them but this processing nevertheless remains more difficult than for the rubber compositions conventionally comprising carbon black as filler.

In particular, it is necessary to use a coupling agent, also known as bonding agent, which has the role of providing the bonding between the surface of the inorganic filler particles and the elastomer, while facilitating the dispersion of this inorganic filler within the elastomeric matrix.

It should be remembered here that the term “coupling agent” (inorganic filler/elastomer) has to be understood as meaning, in a known way, an agent capable of establishing a satisfactory bond, of chemical and/or physical nature, between the inorganic filler and the diene elastomer; such an at least bifunctional coupling agent has, for example, the simplified general formula “Y—W—X”, in which:

Y represents a functional group (“Y” functional group) which is capable of being bonded physically and/or chemically to the inorganic filler, it being possible for such a bond to be established, for example, between a silicon atom of the coupling agent and the to surface hydroxyl (OH) groups of the inorganic filler (for example the surface silanols, when silica is concerned);

X represents a functional group (“X” functional group) which is capable of being bonded physically and/or chemically to the diene elastomer, for example via a sulphur atom;
W represents a divalent group which makes it possible to connect Y and X.

The coupling agents should in particular not be confused with simple covering agents for inorganic filler which, in a known way, can comprise the Y functional group, active with regard to the inorganic filler, but are devoid of the X functional group, active with regard to the diene elastomer.

Among the many existing coupling agents, mercaptosilanes prove to be particularly advantageous; however, given their very high reactivity, blocked mercaptosilanes are generally used.

It should be remembered here that blocked mercaptosilanes, in a way well known to a person skilled in the art, are silane precursors capable of forming mercaptosilanes during the preparation of the rubber compositions (see, for example, US 2002/0115767 A1 or International Application WO 02/48256). The molecules of these silane precursors, hereinafter referred to as blocked mercaptosilanes, have a blocking group instead of the hydrogen atom of the corresponding mercaptosilane. The blocked mercaptosilanes are capable of being deblocked by replacement of the blocking group by a hydrogen atom, during the compounding and curing, in order to result in the formation of a more reactive mercaptosilane, defined as a silane having a molecular structure which comprises at least one thiol (—SH) (mercapto-) group bonded to a carbon atom and at least one silicon atom. These blocked mercaptosilane coupling agents are thus generally used in the presence of a blocked mercaptosilane activator, the role of which is to initiate, accelerate or amplify the activity of the blocked mercaptosilane, as is specified in particular in Patent U.S. Pat. No. 7,122,590.

Such an activator or “deblocking agent” for tire rubber compositions is generally composed of a guanidine, in particular N,N′-diphenylguanidine, DPG.

### SUMMARY

The Applicant has discovered, surprisingly, that novel and specific blocked to mercaptosilanes which, unexpectedly, make it possible to overcome all of these disadvantages and thus in particular to be used as coupling agent, specific blocked mercaptosilanes simultaneously devoid or virtually devoid of guanidine derivatives and devoid or virtually devoid of zinc oxide, make it possible to obtain a similar compromise in properties to that obtained with the same mercaptosilanes in the presence of guanidine derivatives and zinc oxide.

It should be noted that the vulcanization of diene elastomers by sulphur is widely used in the rubber industry, in particular in the tire industry. In order to vulcanize diene elastomers, use is made of a relatively complex vulcanization system comprising, in addition to the sulphur, various vulcanization accelerators and also one or more vulcanization activators, very particularly zinc derivatives, such as zinc oxide (ZnO) or zinc salts of fatty acids, such as zinc stearate.

A medium-term objective of tire manufacturers is to eliminate zinc or its derivatives from their rubber formulations, due to the known relatively toxic nature of these compounds, in particular with respect to water and aquatic organisms (classification R50 according to European Directive 67/548/EC of 9 Dec. 1996).

However, it is found that the elimination of zinc oxide, specifically from rubber compositions reinforced with an inorganic filler, such as silica, is very highly damaging to the processing characteristics (“processability”) of rubber compositions in the raw state, with a reduction in the scorch time which is absolutely unacceptable from the industrial viewpoint. It should be remembered that the “scorching” phenomenon rapidly results, during the preparation of the rubber compositions in a mixer, in premature vulcanizations (“scorching”), in very high viscosities in the raw state, finally in rubber compositions which are virtually impossible to work and to process industrially.

Thus, the combination of these negligible, indeed even nonexistent, amounts of guanidine derivatives and zinc oxide in compositions comprising silica and specific blocked mercaptosilanes as coupling agent makes it possible, surprisingly, for the coupling agent to react without requiring the presence of a deblocking agent and without a deterioration in the properties of this composition.

Consequently, a first subject-matter of the invention is a blocked mercaptosilane corresponding to the general formula (I):

(HO) R₂¹Si—Z—S—C (═O)—A

in which:
the symbols R¹, which are identical or different, each represent a monovalent hydrocarbon group chosen from linear or branched alkyls, cycloalkyls or aryls having from 1 to 18 carbon atoms;
the symbol A represents hydrogen or a monovalent hydrocarbon group chosen from linear or branched alkyls, cycloalkyls or aryls having from 1 to 18 carbon atoms and linear or branched alkoxyalkyls having from 2 to 8 carbon atoms;
the symbol Z represents a divalent bonding group comprising from 1 to 18 carbon atoms.

Moreover, a subject-matter of the invention is a process for producing a mercaptosilane of general formula (I) which comprises the following stages:
the starting material is a blocked mercaptosilane (hereinafter product B) of formula (B):

(R²O) R₂¹ Si—Z—S—C (═O)—A
in which:
R¹, A and Z have the same meanings as in the formula (I);
R², which are identical or different, represent a monovalent hydrocarbon group chosen from alkyls having from 1 to 6, preferably from 1 to 3;
a hydrolysis is carried out in an acidic medium, which makes it possible to result in the targeted blocked mercaptosilane of formula (I).

### DETAILED DESCRIPTION OF SPECIFIC EMBODIMENTS

I. Measurements and Tests Used

The rubber compositions in which the coupling agents are tested are characterized, before and after curing, as indicated below.

I-1. Tensile Tests

These tensile tests make it possible to determine the elasticity stresses and the properties at break. Unless otherwise indicated, they are carried out in accordance with French Standard NF T 46-002 of September 1988. The nominal secant modulus (or apparent stress, in MPa) is measured in second elongation (i.e. after an accommodation cycle at the extension rate provided for the measurement itself) at 100% elongation (denoted M100) and at 300% elongation (M300).

I-2. Dynamic Properties

The dynamic properties ΔG* and tan(δ)ₘₐₓ are measured on a viscosity analyser (Metravib VA4000) according to Standard ASTM D 5992-96. The response of a sample of vulcanized composition (cylindrical test specimen with a thickness of 4 mm and with a cross section of 400 mm²), subjected to a simple alternating sinusoidal shear stress, at a frequency of 10 Hz, at 23° C. or 40° C., is recorded. A strain amplitude sweep is carried out from 0.1% to 50% (outward cycle) and then from 50% to 1% (return cycle). The results made use of are the complex dynamic shear modulus (G*) and the loss factor (tan δ). The maximum value of tan δ observed (tan(δ)ₘₐₓ) and the difference in complex modulus (ΔG*) between the values at 0.1% and at 50% strain (Payne effect) are shown for the return cycle.

II. Conditions for the Implementation of the Invention

II-1. Blocked Mercaptosilane of the Invention

The first subject-matter of the invention is a mercaptosilane of general formula (I):

(HO)₂ R¹—Si—Z—S—C (═O)—A

in which:
R¹ represents a monovalent hydrocarbon group chosen from linear or branched alkyls, cycloalkyls or aryls having from 1 to 18 carbon atoms;
A represents hydrogen or a monovalent hydrocarbon group chosen from linear or branched alkyls, cycloalkyls or aryls having from 1 to 18 carbon atoms;
Z represents a divalent bonding group comprising from 1 to 18 carbon atoms.

Z can comprise one or more heteroatoms chosen from O, S and N.

Advantageously:
R¹ is chosen from methyl, ethyl, n-propyl and isopropyl, preferably from methyl and ethyl;
A is chosen from alkyls having from 1 to 18 carbon atoms and the phenyl radical;
Z is chosen from C₁-C₁₈ alkylenes and C₆-C₁₂ arylenes.

According to one embodiment, Z is chosen from C₁-C₁₀ alkylenes and more preferably Z is chosen from C₁-C₄ alkylenes.

According to another embodiment, R¹ is a methyl.

Preferably, A is chosen from alkyls having from 1 to 7 carbon atoms and the phenyl radical.

Mention will in particular be made of S-octanoylmercaptopropyldihydroxymethylsilane, the formula (I)° of which is such that R¹ is a methyl, Z is a propylene and A is a heptyl.

II-2. Process of Synthesis

The process in accordance with the invention for preparing a blocked mercaptosilane of formula (I) above comprises the following stages:

The starting material is a blocked mercaptosilane (hereinafter product B) of formula (B):

(R²O) R₂¹Si—Z—S—C (═O)—A

in which:
R¹, A and Z have the same meanings as in the formula (I);
R², which are identical or different, represent a monovalent hydrocarbon group chosen from alkyls having from 1 to 6, preferably from 1 to 3;

It should be noted that the product B can in particular be obtained from a “non-blocked” to mercaptosilane by subjecting it to a thioesterification.

A hydrolysis is carried out in an acidic medium, which makes it possible to result in the targeted blocked mercaptosilane of formula (I).

I-3. Use as Coupling Agent

As indicated above, the compound of the invention, by virtue of its twofold functionality, has an advantageous industrial application as coupling agent intended, for example, to provide the bonding or adhesion between a reactive polymeric matrix (in particular a rubber matrix) and any material having a hydroxylated surface, in particular a mineral material (for example, a glass fibre) or a metallic material (for example, a wire made of carbon steel or of stainless steel).

Without this being limiting, it can be used in particular for the coupling of reinforcing inorganic or white fillers and diene elastomers, for example in rubber compositions intended for the manufacture of tires. The term “reinforcing inorganic filler” is understood as meaning, in a known way, an inorganic or mineral filler, whatever its colour and its origin (natural or synthetic), also known as “white filler” or sometimes “clear filler”, in contrast to carbon black, this inorganic filler being capable of reinforcing, by itself alone, without means other than an intermediate coupling agent, a rubber composition intended for the manufacture of tires, in other words capable of replacing, in its reinforcing role, a conventional tire-grade carbon black filler.

For such a use, the diene elastomer is then preferably selected from the group of highly unsaturated diene elastomers consisting of polybutadienes (BRs), synthetic polyisoprenes (IRs), natural rubber (NR), butadiene/styrene copolymers (SBRs), butadiene/isoprene copolymers (BIRs), butadiene/acrylonitrile copolymers (NBRs), isoprene/styrene copolymers (SIRs), butadiene/styrene/isoprene copolymers (SBIRs) and the mixtures of these elastomers.

When the monohydroxysilane of the invention is intended for coupling (inorganic filler/diene elastomer) in a rubber composition forming, for example, all or a portion of a passenger vehicle tire tread, the diene elastomer is then preferably an SBR or a blend (mixture) of SBR and of another diene elastomer, such as BR, NR or IR. In the case of an SBR elastomer, use is made in particular of an SBR having a styrene content of between 20% and 30% by weight, a content of vinyl bonds of the butadiene part of between 15% and 65%, a content of trans-1,4-bonds of between 15% and 75% and a glass transition temperature (Tg—measured according to Standard ASTM D3418-82) of between −20° C. and −55° C., this SBR copolymer, preferably prepared in solution (SSBR), optionally to being used as a mixture with a polybutadiene (BR) preferably having more than 90% of cis-1,4-bonds.

When the tread is intended for a utility tire, such as a heavy duty vehicle tire, the diene elastomer is then preferably an isoprene elastomer, that is to say a diene elastomer selected from the group consisting of natural rubber (NR), synthetic polyisoprenes (IRs), the various isoprene copolymers and the mixtures of these elastomers; it is then more preferably natural rubber or a synthetic polyisoprene of the cis-1,4-type having a content (mol %) of cis-1,4- bonds of greater than 90%, more preferably still of greater than 98%.

The blocked mercaptosilanes of the invention have proved to be sufficiently effective by themselves alone for the coupling of a diene elastomer and a reinforcing inorganic filler, such as silica, used at a preferred content of greater than 1 phr (parts by weight per hundred parts of elastomer), more preferably of between 2 and 20 phr. They can advantageously constitute the sole coupling agent present in rubber compositions reinforced with inorganic filler and intended for the manufacture of tires.

Mention will be made, as reinforcing inorganic filler, of mineral fillers of the siliceous type, in particular silica (SiO₂), or of the aluminous type, in particular alumina (Al₂O₃), or of aluminium (oxide) hydroxides, or also of reinforcing titanium oxides, as described in the abovementioned patents or patent applications.

III. Examples of the Implementation of the Invention

III-1 Blocked Mercaptosilanes Used

III-1.1 Silane NXT (Mercaptosilane “M1”) Not in Accordance with the Invention

It should be remembered that Silane NXT is S-octanoylmercaptopropyltriethoxysilane having the expanded formula (Et=ethyl):

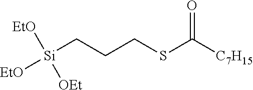

Use is made, in the examples, of the S-octanoylmercaptopropyltriethoxysilane sold under the name “Silane NXT™” by GE Silicones.

III-1.2 S-Octanoylmercaptopropylhydroxydimethylsilane (Mercaptosilane “M2”) in Accordance with the Invention

One of the blocked mercaptosilanes employed in the tests which follow is

S-octanoylmercaptopropylhydroxydimethylsilane, of formula:

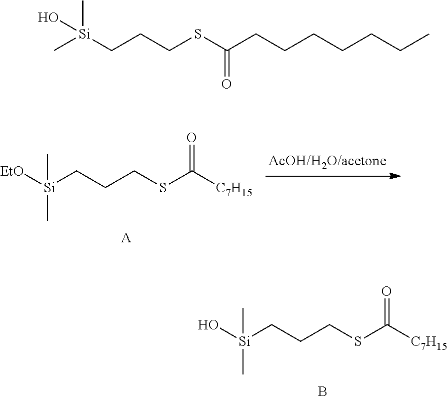

The preparation of S-octanoylmercaptopropylethoxydimethylsilane A having the CAS number [1024594-66-8] is described in the Michelin Patent Application FR 2 940 301/WO 2010072682.

The product B is prepared by hydrolysis in a catalytic acidic medium.

S-Octanoylmercaptopropylethoxydimethylsilane A (59.0 g, 0.194 mol) is added to a mixture of 1% acetic acid, demineralized water (60 ml) and acetone (300 ml). The solution is stirred at ambient temperature for 1.5-2 hours. After evaporation of the solvents at 20-23° C. under reduced pressure, the mixture obtained is chromatographed on a silica column (eluent mixture of petroleum ether and ethyl acetate in a 1:1 ratio).

After evaporation of the solvents at 20-24° C. under reduced pressure, an oil (41 g, 0.148 mol, yield of 76%) is obtained. The NMR analysis confirms the structure of the S-octanoylmercaptopropylhydroxydimethylsilane obtained with a molar purity of greater than 97%.

The NMR analysis is carried out in d₆-acetone.

Calibration: 1.98 ppm with regard to the residual ¹H signal of the acetone and 29.8 ppm with regard to the signal of the ¹³C.

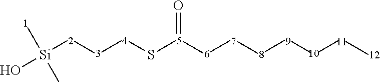 [SMILES: CCCCCCCC(=O)SCCC[Si](C)(C)O]

| Atom | δ ¹H (ppm) | δ ¹³C (ppm) |
|---|---|---|
| 1 | −0.01 | −0.3 |
| 2 | 0.56 | 17.9 |
| 3 | 1.55 | 24.5 |
| 4 | 2.80 | 32.2 |
| 5 | — | 198.7 |
| 6 | 2.48 | 44.2 |
| 7 | 1.55 | 26.0 |
| 8 | 1.18 → 1.29 | 29.3 |
| 9 | 1.18 → 1.29 | 31.3 |
| 10 | 1.18 → 1.29 | 32.0 |
| 11 | 1.18 → 1.29 | 23.0 |
| 12 | 0.81 | 14.0 |
| OH | ~4.30 | — |

Chemical shift ²⁹Si: 16.3 ppm (calibration with respect to the TMS)

III-2 Preparation of the Rubber Compositions

The following tests are carried out in the following way: the diene elastomer (SBR and BR blend), the silica, supplemented by a small amount of carbon black, the coupling agent and then, after kneading for one to two minutes, the various other ingredients, with the exception of the vulcanization system, are introduced into an internal mixer which is 70% filled and which has an initial vessel temperature of approximately 90° C. Thermomechanical working is then carried out (non-productive phase) in one stage (total duration of the kneading equal to approximately 5 min), until a maximum “dropping” temperature of approximately 165° C. is reached. The mixture thus obtained is recovered and cooled and then the covering agent (when the latter is present) and the vulcanization system (sulphur and sulphenamide accelerator) are added on an external mixer (homofinisher) at 70° C., everything being mixed (productive phase) for approximately 5 to 6 min.

The compositions thus obtained are subsequently calendered, either in the form of plaques (thickness of 2 to 3 mm) or thin sheets of rubber, for the measurement of their physical or mechanical properties, or in the form of profiled elements which can be used directly, after cutting and/or assembling to the desired dimensions, for example as semi-finished products for tires, in particular as tire treads.

III-3 Characterization of the Rubber Compositions

The aim of this test is to demonstrate the improved properties of rubber compositions for tire treads according to the invention having silica as reinforcing filler, which is devoid of guanidine derivatives, more specifically devoid of DPG, and devoid of zinc, comprising a blocked mercaptosilane of formula (I) (M2), compared with a control composition conventionally comprising the commercial blocked mercaptosilane M1, DPG and zinc.

For this, 2 compositions based on a diene elastomer (SBR/BR blend) are prepared which are reinforced with a highly dispersible silica (HDS).

These two compositions differ essentially in the technical characteristics which follow:
the composition C1 is a control composition comprising DPG (1.5 phr) and zinc (1.5 phr of ZnO),
the composition C2 in accordance with the intention, devoid of DPG and zinc and comprising the mercaptosilane M2.

It should be noted that, in order to be able to compare the properties of the compositions C1 and C2, the blocked mercaptosilane coupling agent of the composition C2 is used at an isomolar silicon content in comparison with the control composition C1.

Tables 1 and 2 give the formulations of various compositions (Table 1—contents of the various products, expressed in phr or parts by weight per hundred parts of elastomer) and their properties after curing (approximately 40 min at 150° C.); the vulcanization system is composed of sulphur and sulphenamide.

Table 2 emphasizes the fact that the composition C2 in accordance with the invention, comprising a blocked mercaptosilane of formula (I) and devoid of DPG and zinc, makes it possible to have a reinforcement (M300/M100) comparable to the conventional control composition C1 comprising the blocked mercaptosilane M1 and also DPG and zinc.

Furthermore, it may be noted that the use of a blocked mercaptosilane in accordance with the invention is particularly advantageous from the environmental viewpoint. It makes it possible simultaneously to overcome the problems due to the elimination of the zinc.

TABLE 1

Composition
No.

| | C1 | C2 |
|---|---|---|
| SBR (1) | 70 | 70 |
| BR (2) | 30 | 30 |
| Silica (3) | 70 | 70 |
| Mercaptosilane M1 | 7.78 | — |
| Mercaptosilane M2 | — | 5.9 |
| Carbon black (4) | 3 | 3 |
| Plasticizing oil (5) | 15 | 15 |
| Plasticizing resin (6) | 8.5 | 8.5 |
| DPG (7) | 1.5 | — |
| Antiozone wax (8) | 1.5 | 1.5 |
| ZnO (9) | 1.5 | — |
| Antioxidant (10) | 2 | 2 |
| Stearic acid (11) | 2 | 2 |
| Sulphur | 1 | 1 |
| Accelerator (12) | 1.6 | 1.6 |

(1) SSBR with 41% of styrene, 41% of 1,2-polybutadiene units and 37% of trans-1,4-polybutadiene units (Tg = −12° C.);
(2) BR (Nd) with 0.7% of 1,2-; 1.7% of trans-1,4-; 98% of cis-1,4-(Tg = −105° C.);
(3) Silica, Zeosil 1165 MP, from Rhodia in the form of microbeads (BET and CTAB: approximately 150-160 m²/g);
(4) N234 (Degussa);
(5) Oleic sunflower oil (Agripure 80 from Cargill);
(6) Polylimonene resin (Resine THER 8644 from Cray Valley);
(7) Diphenylguanidine (Perkacit DPG from Flexsys);
(8) Mixture of macro- and microcrystalline antiozone waxes;
(9) Zinc oxide (industrial grade - Umicore);
(10) N-(1,3-Dimethylbutyl)-N-phenyl-para-phenylenediamine (Santoflex 6-PPD from Flexsys);
(11) Stearin (Pristerene 4931 - Uniqema);
(12) N-Cyclohexyl-2-benzothiazolesulphenamide (Santocure CBS from Flexsys).

TABLE 2

Composition
No.

| Properties after curing | C1 | C2 |
|---|---|---|
| M300/M100 | 1.34 | 1.26 |
| ΔG* (MPa) | 1.36 | 1.27 |

1. A blocked mercaptosilane corresponding to the formula:
(HO) R₂¹Si—Z—S—C (═O)—A
wherein:
the symbols R¹, which are identical or different, each represent a monovalent hydrocarbon group chosen from linear or branched alkyls, cycloalkyls or aryls having from 1 to 18 carbon atoms;
the symbol A represents hydrogen or a monovalent hydrocarbon group chosen from linear or branched alkyls, cycloalkyls or aryls having from 1 to 18 carbon atoms and linear or branched alkoxyalkyls having from 2 to 8 carbon atoms;
the symbol Z represents a divalent bonding group comprising from 1 to 18 carbon atoms.

2. The mercaptosilane according to claim 1, wherein Z comprises one or more heteroatoms selected from the group consisting of O, S and N.

3. The mercaptosilane according to claim 1, wherein:
R¹ is selected from the group consisting of methyl, ethyl, n-propyl and isopropyl;
A is chosen from alkyls having from 1 to 18 carbon atoms and the phenyl radical;
Z is chosen from C₁-C₁₈ alkylenes and C₆⁻C₁₂ arylenes.

4. The mercaptosilane according to claim 3, wherein Z is chosen from C₁-C₁₀ alkylenes.

5. The mercaptosilane according to claim 4, wherein Z is chosen from C₁-C₄ alkylenes.

6. The mercaptosilane according to claim 3, wherein R¹ is a methyl.

7. The mercaptosilane according to claim 3, wherein A is chosen from alkyls having from 1 to 7 carbon atoms and the phenyl radical.

8. The mercaptosilane according to any one claim 3, wherein R¹ is methyl, Z is a propylene and A is a heptyl.

9. A process for producing a mercaptosilane according to claim 1, comprising:
providing a starting material that is a blocked mercaptosilane (hereinafter product B) of formula (B):
(R²O) R₂¹Si—Z—S—C (═O)—A
wherein:
R¹, A and Z have the same meanings as in the formula (I);
R², which are identical or different, represent a monovalent hydrocarbon group chosen from alkyls having from 1 to 6;
hydrolyzing product B in an acidic medium, thereby producing the targeted blocked mercaptosilane of formula (I).

10. A method of coupling an inorganic filler to a diene elastomer comprising introducing a coupling agent comprising a mercaptosilane according to any one of claim 1.

11. The method according to claim 11, wherein the inorganic filler, the diene elastomer, and the coupling agent form a rubber composition.

12. A rubber composition based on components comprising a diene elastomer, a reinforcing inorganic filler, and a coupling agent, wherein the coupling agent is the mercaptosilane according to claim 1, and wherein amounts of any guanidine derivatives or zinc oxide is negligible or nonexistent.

13. The rubber composition according to claim 12, wherein the mercaptosilane is the sole coupling agent.

14. A tire comprising the rubber composition according to claim 12.
